(19) United States
(12) Patent Application Publication
(10) Pub. No.: US 2013/0332531 A1
(43) Pub. Date: Dec. 12, 2013

(54) INFORMATION PROCESSING DEVICE AND MEETING SYSTEM

(71) Applicant: Seiichiroh SATOH, Tokyo (JP)

(72) Inventor: Seiichiroh SATOH, Tokyo (JP)

(21) Appl. No.: 13/910,397

(22) Filed: Jun. 5, 2013

(30) Foreign Application Priority Data
Jun. 8, 2012 (JP) 2012-131371
Jan. 15, 2013 (JP) 2013-004961

(51) Int. Cl. H04L 29/06

(52) U.S. Cl. CPC H04L 65/403
USPC 709/204

(57) ABSTRACT

An information processing apparatus communicating with a device associated with a participant of an event, includes: a unit configured to detect the device upon the participant entering the event; a unit configured to update a presence information in response to the detection; a unit configured to update a conferring information upon the event being held; and a unit configured to control access to event materials from the device according to a value of the presence information and the conferring information.

### CROSS REFERENCE TO RELATED APPLICATION

The present application claims a benefit of priority to and incorporates by reference the entire contents of Japanese Patent Application No. 2012-131371 filed in Japan on Jun. 8, 2012, and Japanese Patent Application No. 2013-004961 filed in Japan on Jan. 15, 2013.

### BACKGROUND OF THE INVENTION

1. Field of the Invention

The present invention relates to a information processing device, a meeting system and computer program.

2. Description of the Related Art

Conventionally, computerized meeting systems have been known for accomplishing paperless meetings. In such a conventional computerized meeting system, a participant attending the meeting can shear computerized materials that are distributed to participant's information processing terminal by a server device (see Japanese Patent Application Laid-open Publication No. 2011-182051, which is incorporated herein by reference).

However, the conventional computerized meeting system as mentioned above, if the participant uses a mobile and/or portable information processing terminal, it is impossible to restrict access to the meeting materials based on geographical location of the participant. This leads disadvantage of security problem.

Therefore, there is a need for a server device, a meeting system, and a computer program capable of increasing security against information leakage.

### SUMMARY OF THE INVENTION

According to an aspect of the invention, an information processing apparatus communicating with a device associated with a participant of an event is provided. The information processing apparatus includes: a unit configured to detect the device upon the participant entering the event; a unit configured to update a presence information in response to the detection; a unit configured to update a conferring information upon the event being held; and a unit configured to control access to event materials from the device according to a value of the presence information and the conferring information.

According to further aspect of the invention, an event system is provided. The event system comprising: a device associated with a participant of an event; a unit configured to detect the device upon the participant entering the event; a unit configured to update a presence information in response to the detection; a unit configured to update a conferring information upon the event being held; and a unit configured to control access to event materials from the device according to a value of the presence information and the conferring information.

According to further aspect of the invention, a method of performing a processing of information communication to a device associated with a participant of an event is provided. The method includes: detecting the device upon the participant entering the event; updating a presence information in response to the detection; updating a conferring information upon the event being held; and controlling an access to event materials from the device according to a value of the presence information and the conferring information.

The above and other objects, features advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is an exemplary schematic diagram of a meeting system according to an embodiment of the present invention;

FIG. 2 is an exemplary block diagram of the structure of a server device according to the embodiment;

FIG. 3 is an exemplary diagram of meeting information according to the embodiment;

FIG. 4 is an exemplary diagram of user information according to the embodiment;

FIG. 5 is an exemplary diagram of terminal information according to the embodiment;

FIG. 6 is an exemplary diagram of meeting control information according to the embodiment;

FIG. 7 is an exemplary block diagram of the structure of a terminal device according to the embodiment;

FIG. 8 is an exemplary sequence diagram of meeting start processing executed in the meeting system according to the embodiment;

FIG. 9 is an exemplary diagram of meeting control information at the time when meeting start processing has been commenced;

FIG. 10 is an exemplary diagram of meeting control information at the time when the participant has entered a meeting room;

FIG. 11 is an exemplary diagram of meeting control information at the time when a development review has been commenced;

FIG. 12 is an exemplary sequence diagram of meeting attendance processing performed in the meeting system according to the embodiment;

FIG. 13 is an exemplary diagram of meeting control information at the time when the participant has entered the meeting room during the meeting;

FIG. 14 is an exemplary diagram of meeting control information at the time when the participant attends the development review during the meeting;

FIG. 15 is an exemplary sequence diagram of out of the meeting processing performed in the meeting system according to the embodiment;

FIG. 16 is an exemplary diagram of meeting control information at the time when the participant has left the meeting room during the meeting;

FIG. 17 is an exemplary sequence diagram of meeting termination processing performed in the meeting system according to the embodiment;

FIG. 18 is an exemplary diagram of meeting control information at the time when a development review ends;

FIG. 19 is an exemplary diagram of meeting control information at the time when all participants have left the meeting room;

FIG. 20 is an exemplary diagram of meeting control information after all participants left the meeting room;

FIG. 21 is an exemplary flowchart of meeting materials view confirmation processing performed in the terminal device according to the embodiment;

FIG. 22 is an exemplary flowchart of meeting materials view confirmation processing performed in the server device according to the embodiment;

FIG. 23 is an exemplary block diagram of the structure of a server device according to other embodiment of the present invention;

FIG. 24 is an exemplary block diagram of the structure of a terminal device according to other embodiment;

FIG. 25 is an exemplary flowchart of meeting materials view confirmation processing performed in the terminal device according to other embodiment; and

FIG. 26 is an exemplary schematic diagram of a meeting system according to other embodiment of the present invention.

FIG. 27 is an exemplary schematic diagram of a meeting system according to other embodiment of the present invention.

FIG. 28 is an exemplary schematic diagram of a meeting system according to other embodiment of the present invention.

### DETAILED DESCRIPTION OF THE PREFERRED EMBODIMENTS

In the following, a server device, a meeting system, and a computer program of the present invention will now be described with reference to the accompanying drawings.

First, the structure of the meeting system is described according to the embodiment of the present invention.

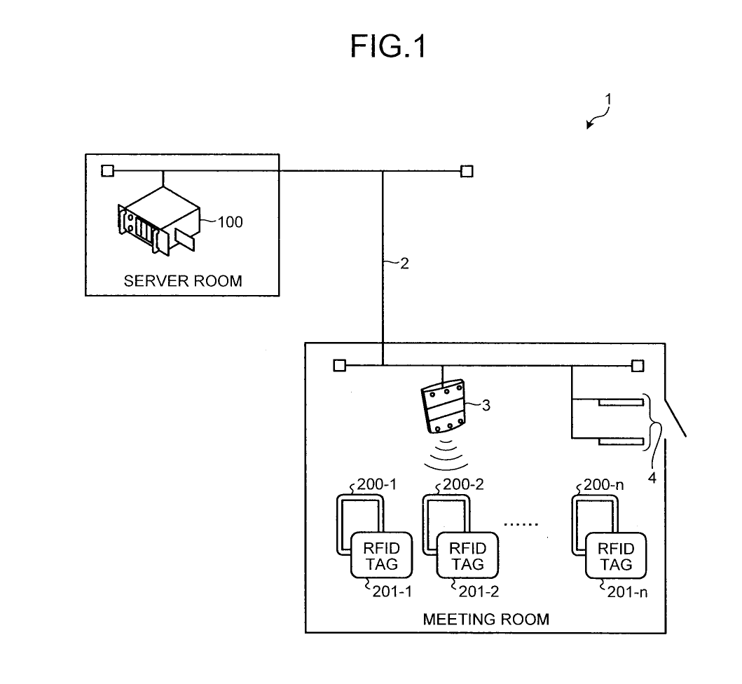

FIG. 1 shows an exemplary meeting system 1 according to an embodiment of the present invention. As illustrated in FIG. 1, the meeting system 1 includes, a local area network (LAN) 2, a wireless LAN 3, a gate 4, a server device 100 as an example of an information processing unit, and terminal devices (200-1, . . . , 200-n (n is a natural number)).

The server device 100 and the gate 4 are connected with each other via the LAN 2, and the server device 100 and the terminal devices 200-1 to 200-n are connected with each other via the LAN 2 and the wireless LAN 3. In the present embodiment, the LAN 2 and the wireless LAN 3 are examples of network. Any other kinds of network may be used, such as a virtual private network (VPN).

The server device 100 controls access to computerized meeting materials (hereinafter, simply referred to as “meeting materials”) by the terminal devices (200-1, . . . , 200-n) and may be realized with a personal computer (PC), in which a paperless meeting program for servers has been installed, for example. The server device 100 is provided in a server room in this embodiment, however, the present invention is not limited thereto.

The terminal devices (200-1, . . . , 200-n) access the meeting materials and may be realized with a mobile and/or portable terminal such as a tablet PC or laptop PC, in which a paperless meeting program for clients has been installed in advance. For example, radio frequency identification (RFID) tags (201-1, . . . , 201-n) to be detected are attached to the corresponding terminal devices (200-1, . . . , 200-n). Each of RFID tags (201-1, . . . , 201-n) stores a unique RFID ID for self-identification.

The gate 4, an example of a detection unit, represent a reader of RFIDs. The gate 4 is provided at an entrance of a chamber, such as a hall or a meeting room in which a meeting is held (hereinafter, a meeting chamber). The gate 4 detects the RFID tags (201-1, . . . , 201-n) each of that is attached to the corresponding terminal devices (200-1, . . . , 200-n). As a example of a meeting chamber, a meeting room is described below. However, the meeting chamber is not limited thereto. Any meeting chamber may be used as long as it is a space capable of holding a meeting. It should be noted that a meeting is not limited to an interactive discussion. For example, a lecture and a speech in which at least one person listens to a talk of another person are also included at the meeting.

Hereinafter, if distinction of each the terminal devices (200-1, . . . , 200-n) is not required, they may be simply referred to as the terminal device 200. Similarly, if distinction of each the RFID tags (201-1, . . . , 201-n) is not required, they may be simply referred as to the RFID tag 201.

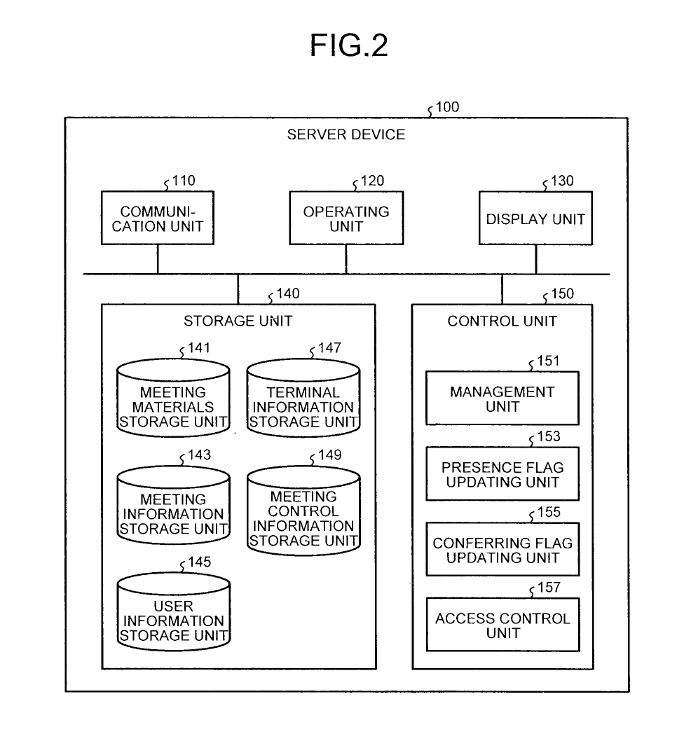

FIG. 2 shows an exemplary structure of a server device 100 according to the embodiment of the present invention. As illustrated in FIG. 2, the server device 100 includes a communication unit 110, an operating unit 120, a display unit 130, a storage unit 140, and a control unit 150.

The communication unit 110 communicates with external devices such as the gate 4 or the terminal devices (200-1 to 200-n) via the LAN 2 or the wireless LAN 3. The communication unit 110 may be realized with a network interface card (NIC) or other communication devices.

The operating unit 120 performs various types of operation inputs and may be realized with a keyboard, a mouse, a touchpad, a touch panel or other input devices.

The display unit 130 displays various types of images and may be realized with a liquid crystal display, a touch panel display, or other display devices.

The storage unit 140 stores various types of programs such as a paperless meeting program for servers to be executed in the server device 100 and the data to be used for various types of processing executed in the server device 100. The storage unit 140 may be realized with a device capable of storing data by magnetics, optics, or electronics, for example a hard disk drive (HDD), a solid state drive (SSD), a memory card, an optical disc, a read only memory (ROM), and a random access memory (RAM). The storage unit 140 includes a meeting materials storage unit 141, a meeting information storage unit 143, a user information storage unit 145, a terminal information storage unit 147, and a meeting control information storage unit 149.

The meeting materials storage unit 141 stores the meeting materials. Specifically, the meeting materials storage unit 141 stores a meeting ID for identifying a meeting and the meeting materials of the meeting in association with each other.

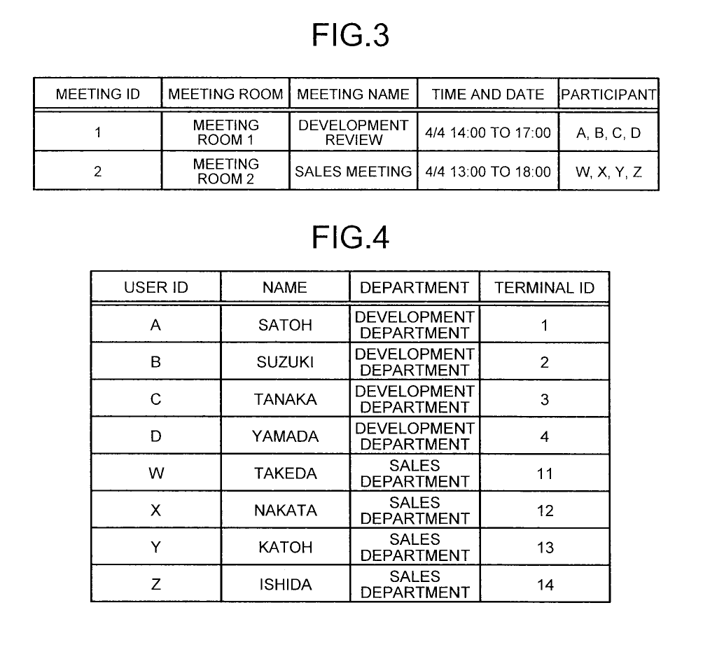

The meeting information storage unit 143 stores meeting information. Specifically, the meeting information storage unit 143 stores the meeting ID for identifying the meeting, the meeting room, the name of the meeting, the time and date the meeting will be held, and a user ID for identifying a participant of the meeting in association with each other. FIG. 3 shows an exemplary meeting information according to the embodiment of the present invention.

The user information storage unit 145 stores user information. Specifically, the user information storage unit 145 stores a user ID for identifying the user, the name of the user, the department of the user, and a terminal ID for identifying the terminal device 200 owned by the user in association with each other. FIG. 4 shows an exemplary user information according to the embodiment of the present invention.

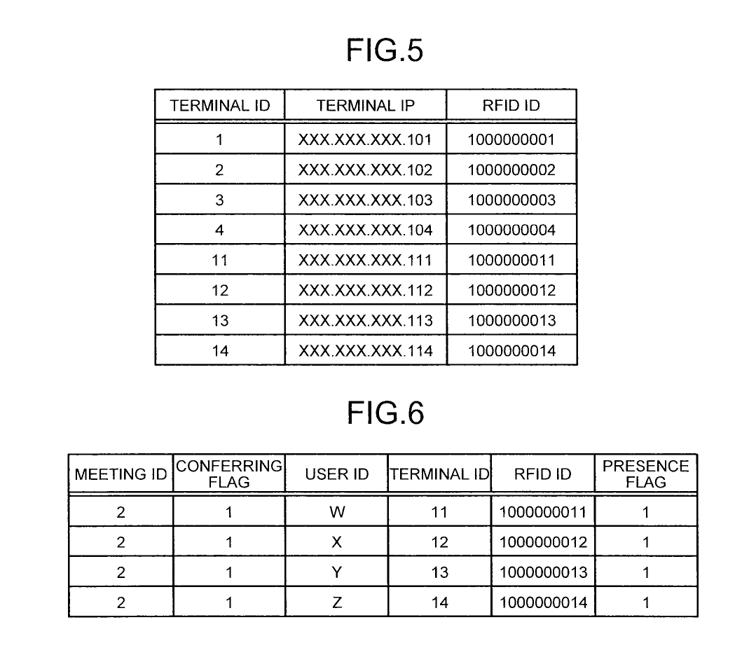

The terminal information storage unit 147 stores terminal information. Specifically, the terminal information storage unit 147 stores a terminal ID for identifying the terminal device 200, a terminal internet protocol (IP) serving as an IP address of the terminal device 200, an RFID ID for identifying the RFID tag 201 attached to the terminal device 200 in association with each other. FIG. 5 shows an exemplary terminal information according to the embodiment of the present invention.

The meeting control information storage unit 149 will be described below.

The control unit 150 controls the components of the server device 100 and may be realized with a central processing unit (CPU) or other control devices. The control unit 150 includes a management unit 151, a presence flag updating unit 153, a conferring flag updating unit 155, and an access control unit 157. The control unit 150 starts up a paperless meeting program for servers stored in the storage unit 140, so that the management unit 151, the presence flag updating unit 153, the conferring flag updating unit 155, and the access control unit 157 are realized by software.

The management unit 151 manages the meetings performed with the meeting system 1. Specifically, the management unit 151 manages the meeting materials being stored in the meeting materials storage unit 141, meeting information being stored in the meeting information storage unit 143, user information being stored in the user information storage unit 145, and terminal information being stored in the terminal information storage unit 147. The management unit 151 uses the meeting information, the user information, and the terminal information to generate meeting control information for each participant of the meeting and stores the meeting control information in the meeting control information storage unit 149. When the meeting terminates, the management unit 151 deletes the corresponding meeting control information from the meeting control information storage unit 149.

FIG. 6 shows an exemplary meeting control information according to the embodiment of the present invention and an exemplary meeting control information of a participant of a sales meeting. As illustrated in FIG. 6, the meeting control information includes a meeting ID, a conferring flag, a user ID, a terminal ID, an RFID ID, and a presence flag in association with each other. The meeting control information, however, is not limited thereto. The conferring flag in the present embodiment indicates whether a meeting is being held or not. When the conferring flag indicates “0”, it means that a meeting represented by the meeting ID is not being held. When the conferring flag indicates “1”, it means that a meeting represented by the meeting ID is being held. The conferring flag in the present embodiment, however, is not limited thereto. The presence flag in the present embodiment indicates whether the terminal device 200 of the participant of the meeting exists in the meeting room or not. When the presence flag indicates “0”, it means that the terminal device 200 represented by the terminal ID does not exist in the meeting room. When the presence flag indicates “1”, it means that the terminal device 200 represented by the terminal ID exists in the meeting room. The presence flag in the present embodiment, however, is not limited thereto. In the example illustrated in FIG. 6, a sales meeting whose meeting ID is “2” is being held, and “Takeda” whose user ID is “W”, “Nakata” whose user ID is “X”, “Katoh” whose user ID is “Y”, and “Ishida” whose user ID is “Z” attend the sales meeting carrying their own terminal devices 200.

The generation method for the meeting control information will be described below.

The presence flag updating unit 153 updates the presence flag in response to upon the gate 4 detects the RFID tag 201 attached to the terminal device 200 of a participant of the meeting. Specifically, when the presence flag indicates “0”, the presence flag updating unit 153 updates the presence flag “0” to “1” in response to upon the gate 4 detects the RFID tag 201. When the presence flag indicates “1”, the presence flag updating unit 153 updates the presence flag “1” to “0” in response to upon the gate 4 detects the RFID tag 201.

As describe above, the gate 4 is provided at the entrance of the meeting room in the present embodiment. Participant of the meeting enters the meeting room through the gate 4. When a participant of the meeting enters the meeting room through the gate 4 carrying his own terminal device 200, the presence flag updating unit 153 updates the presence flag “0” to “1”. When a participant of the meeting leaves the meeting room through the gate 4 carrying his own terminal device 200, the presence flag updating unit 153 updates the presence flag from “1” to “0”.

The conferring flag updating unit 155 updates the conferring flag. Specifically, the conferring flag updating unit 155 updates the conferring flag “0” to “1” in response to a meeting start that has been input from the terminal device 200 of an organizer of the meeting for instructing the start of the meeting; or a meeting attendance that has been input from the terminal device 200 of a participant of the meeting for instructing participation in the meeting or participation during the meeting. The conferring flag updating unit 155 updates the conferring flag “1” to “0” in response to a meeting termination that has been input from the terminal device 200 of an organizer of the meeting for instructing the termination of the meeting.

The access control unit 157 controls access from the terminal device 200 to the meeting materials according to the presence flag and the conferring flag. For example, in response to an access request for access from the terminal device 200 to meeting materials, the access control unit 157 controls the access to the meeting materials from the terminal device 200 according to the presence flag and the conferring flag.

Specifically, when the presence flag indicates “0” or the conferring flag indicates “0”, the access control unit 157 prohibits the terminal device 200 from accessing the meeting materials. For example, when the terminal device 200 requests distribution of the meeting materials, if the presence flag indicates “0” or the conferring flag indicates “0”, the access control unit 157 does not distribute the meeting materials to the terminal device 200. For example, when the terminal device 200 requests view permission determination, if the presence flag indicates “0” or the conferring flag indicates “0”, the access control unit 157 transmits view permission information representing that the terminal device 200 is not permitted to view the meeting materials.

For example, if the presence flag indicates “1” and the conferring flag indicates “1”, the access control unit 157 allows the terminal device 200 to access the meeting materials. For example, when the terminal device 200 requests distribution of the meeting materials, if the presence flag indicates “1” and the conferring flag indicates “1”, the access control unit 157 distributes the meeting materials to the terminal device 200. For example, when the terminal device 200 requests view permission determination, if the presence flag indicates “1” and the conferring flag indicates “1”, the access control unit 157 transmits view permission information representing that the terminal device 200 is permitted to view the meeting materials.

It should be noted that the server device 100 does not necessarily include all of the components described above, and some of them may be omitted.

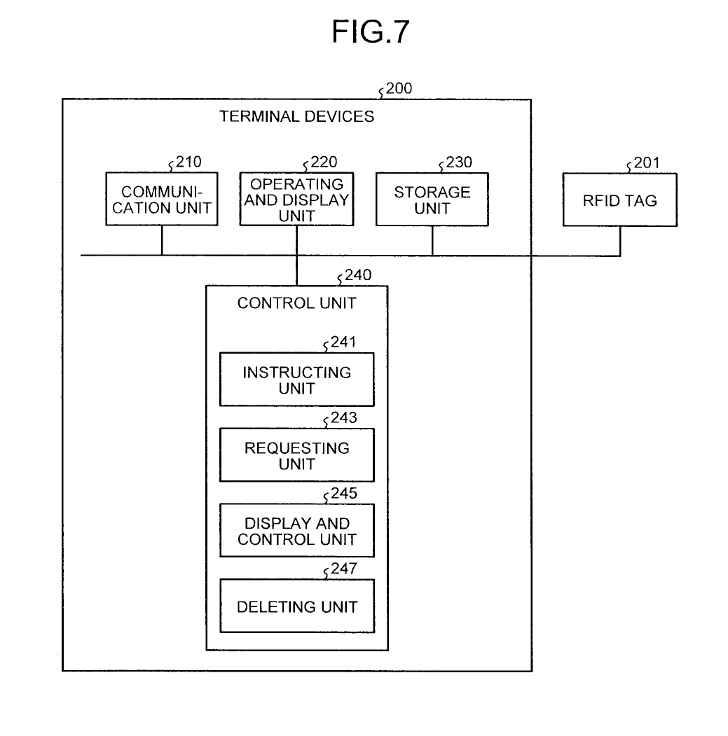

FIG. 7 shows an exemplary structure of the terminal device 200 according to the embodiment of the present invention. As illustrated in FIG. 7, the terminal device 200 includes a communication unit 210, an operating and display unit 220, a storage unit 230, and a control unit 240. The RFID tag 201 is attached to the terminal device 200. The RFID tag 201 is mounted to the terminal device 200 through a universal serial bus (USB) or other external interfaces in the present embodiment. The present embodiment, however, is not limited thereto. The RFID tag 201 may be embedded in the terminal device 200.

The communication unit 210 communicates with external devices such as the server device 100 via the LAN 2 or the wireless LAN 3 and may be realized with a network interface card (NIC) or other communicating devices.

The operating and display unit 220 performs various types of operation inputs and displays various types of images. The operating and display unit 220 may be realized with a touch panel display, for example. It should be noted that the operating unit for performing various types of operation inputs and the operating unit for displaying various types of images may be realized separately.

The storage unit 230 stores various types of programs such as a paperless meeting program for clients to be executed in the terminal device 200 and the data used for various types of processing executed in the terminal device 200. The storage unit 230 may be realized with a device capable of storing data by magnetics, optics, or electronics, for example a hard disk drive (HDD), a solid state drive (SSD), a memory card, an optical disc, a read only memory (ROM), and a random access memory (RAM).

The control unit 240 controls the components of the terminal device 200 and may be realized with a CPU or other control devices. The control unit 240 includes an instructing unit 241, a requesting unit 243, a display and control unit 245, and a deleting unit 247. The control unit 240 starts up a paperless meeting program for clients stored in the storage unit 230, so that the instructing unit 241, the requesting unit 243, the display and control unit 245, and the deleting unit 247 are realized by software.

The instructing unit 241 issues various instructions to the server device 100. For example, when the terminal device 200 is being carried by the organizer of the meeting, the instructing unit 241 performs a meeting start input operation and a meeting termination input for the meeting to the server device 100 in response to the operations through the operating and display unit 220. For example, when the terminal device 200 is being carried by a participant of the meeting who attends the meeting during the meeting, the instructing unit 241 performs a meeting attendance input operation for the meeting in response to the operations through the operating and display unit 220.

The requesting unit 243 requests access to the meeting materials from the server device 100. Specifically, the requesting unit 243 requests distribution of the meeting materials from the server device 100 and receives the meeting materials. The requesting unit 243 requests view permission determination for meeting materials from the server device 100 and receives the meeting materials.

The received meeting materials are stored in a memory area of the storage unit 230, which may be volatile or non-volatile. In the following, exemplary embodiment of a volatile memory area will be described, however, the invention is not limited thereto.

When the requesting unit 243 receives the meeting materials, the display and control unit 245 displays the received meeting materials on the operating and display unit 220. If the view permission information that has been received by the requesting unit 243 represents that viewing the meeting materials is permitted, the display and control unit 245 continues displaying the meeting materials on the operating and display unit 220. If the view permission information that has been received by the requesting unit 243 represents that viewing the meeting materials is not permitted, the display and control unit 245 discontinues displaying the meeting materials on the operating and display unit 220.

If the view permission information that has been received by the requesting unit 243 represents that viewing meeting materials is not permitted, the deleting unit 247 deletes the meeting materials that have been received by the requesting unit 243 and the meeting materials that have been already distributed from the server device 100. Specifically, the deleting unit 247 takes actions so that the meeting materials keep from being read out from the memory area of the storage unit 230 in which the meeting materials are stored.

The terminal device 200 does not necessarily include all of the components described above, and some of them may be omitted.

Operations of the meeting system according to the embodiment of the present invention will now be described.

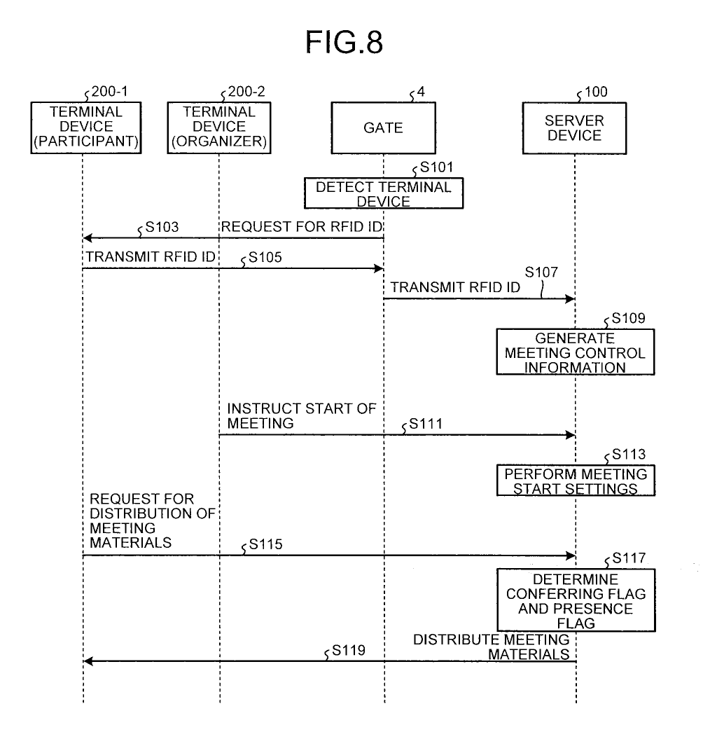

FIG. 8 shows an exemplary sequence of meeting start processing performed in the meeting system 1 according to the embodiment of the present invention. FIG. 8 illustrates an example of the meeting start processing for a development review whose meeting ID is “1”. FIG. 8 illustrates an example of the flow of processing from entry of “Satoh” whose user ID is “A” to a meeting room 1 to the start of the meeting. In the example illustrated in FIG. 8, “Suzuki” whose user ID is “B” and “Tanaka” whose user ID is “C” have already entered the meeting room 1, and “Yamada” whose user ID is “D” will attend the meeting later.

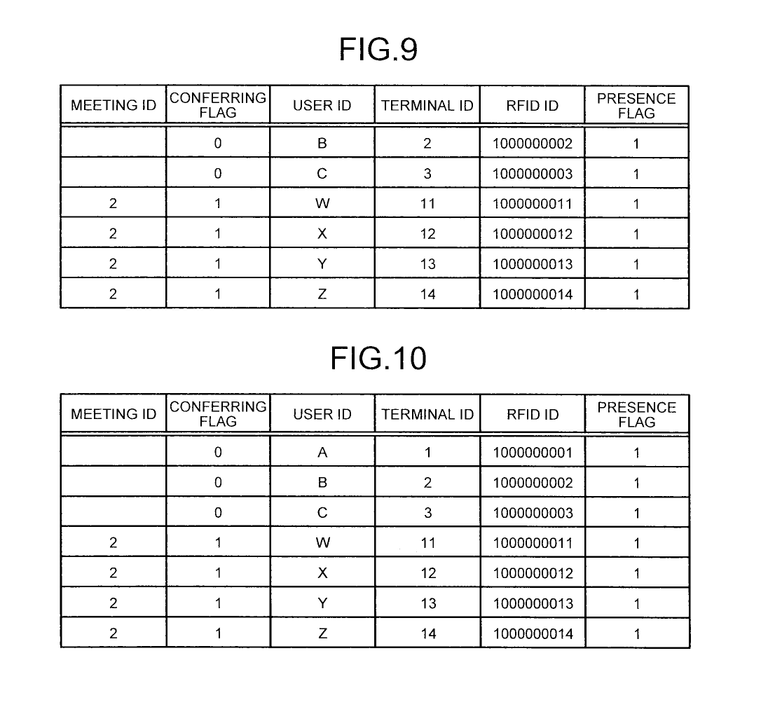

FIG. 9 illustrates the meeting control information that is being stored in the meeting control information storage unit 149 at the time when the meeting start processing in FIG. 8 starts. FIG. 9 illustrates an example of the meeting control information of the meeting, in which “Suzuki” whose user ID is “B” and “Tanaka” whose user ID is “C” have already entered the meeting room 1. The meeting control information of the sales meeting whose meeting ID is “2” is the same as the meeting control information illustrated in FIG. 6.

In the example illustrated in FIG. 8, “Suzuki” whose user ID is “B” is the organizer of the meeting. “Satoh” whose user ID is “A” uses the terminal device 200-1 and “Suzuki” whose user ID is “B” uses the terminal device 200-2.

First, when “Satoh” whose user ID is “A” enters the meeting room 1 carrying the terminal device 200-1, the gate 4 detects the RFID tag 201-1 attached to the terminal device 200-1 (Step S101).

The gate 4 then requests an RFID ID from the detected RFID tag 201-1 (Step S103), and the RFID tag 201-1 transmits its own RFID ID “1000000001” to the gate 4 (Step S105).

The gate 4 subsequently transmits the received RFID ID “1000000001” from the RFID tag 201-1 to the server device 100 (Step S107).

Upon the server device 100 (i.e., the management unit 151) receives the RFID ID “1000000001” of the RFID tag 201-1 from the gate 4, the server device 100 (i.e., the management unit 151) generates the meeting control information of the participant “Satoh” carrying the terminal device 200-1 to which the RFID tag 201-1 is attached (Step S109).

Specifically, the management unit 151 obtains the terminal ID “1” of the terminal device 200-1 to which the RFID tag 201-1 provided with the received RFID ID “1000000001” is attached, with reference to the terminal information illustrated in FIG. 5. The management unit 151 obtains the user ID “A” of the participant who uses the terminal device 200-1 whose terminal ID is “1”, with reference to the user information illustrated in FIG. 4. The management unit 151 associates a meeting ID with the conferring flag “0”, the obtained user ID “A”, the obtained terminal ID “1”, the received RFID ID “1000000001”, and the presence flag “1” to generate the meeting control information of “Satoh” whose user ID is “A”. At this time, any value is not set for the meeting ID. The initial value of the conferring flag is “0” and the initial value of the presence flag is “1”. For example, FIG. 10 illustrates the meeting control information that being stored in the meeting control information storage unit 149 at the time when “Satoh” whose user ID is “A” enters the meeting room.

When “Satoh” whose user ID is “A” enters the meeting room 1, all members are attending the meeting except for “Yamada” whose user ID is “D”, and “Yamada” will attend the meeting later. “Suzuki” whose user ID is “B” is the organizer of the meeting, therefore, performs the meeting start input operation through the operating and display unit 220 of the terminal device 200-2. The instructing unit 241 of the terminal device 200-2 performs the meeting start input to instruct the start of the development review to the server device 100 (Step S111). The meeting start input includes the meeting ID “1” of the development review and the user IDs “A”, “B”, and “C” of the members to attend the development review.

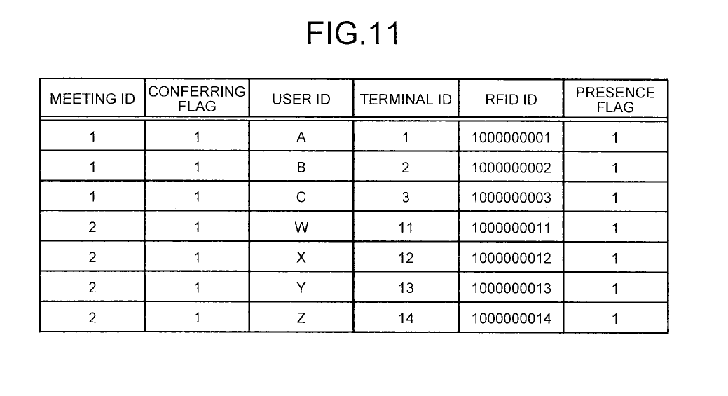

Once the meeting start input is performed, the server device 100 (the management unit 151 and the conferring flag updating unit 155) confirms that there are no problems with the meeting ID and the user IDs included in meeting start input, with reference to the meeting information illustrated in FIG. 3. The server device 100 (the management unit 151 and the conferring flag updating unit 155) then performs meeting start settings on the meeting control information (Step S113). Specifically, the management unit 151 sets the conferring flag of the meeting ID of the meeting control information whose user IDs are “A”, “B”, and “C”, to “1”. The conferring flag updating unit 155 updates the conferring flag of the meeting control information whose user IDs are “A”, “B”, and “C”, to “1”. Once the development review is started, therefore, the meeting control information stored in the meeting control information storage unit 149 represents the meeting control information as illustrated in FIG. 11.

“Satoh” whose user ID is “A” performs an operation for requesting distribution of the meeting materials through the operating and display unit 220 of the terminal device 200-1. The requesting unit 243 of the terminal device 200-1 requests distribution of the meeting materials of the development review from the server device 100 (Step S115).

The request for distribution of the meeting materials includes the meeting ID “1” and the terminal ID “1” of the development review.

When the server device 100 (i.e., the access control unit 157) receives the request for distribution of the meeting materials, the server device 100 (i.e., the access control unit 157) determines whether both the conferring flag and the presence flag are “1” or not in the meeting control information whose the terminal ID is “1” included in the distribution request of the meeting materials, with reference to the meeting control information illustrated in FIG. 11 (Step S117). In the example illustrated in FIG. 11, both the conferring flag and the presence flag are “1”, thus the access control unit 157 obtains the meeting materials associated with meeting ID “1” included in the distribution request of the meeting materials from the meeting materials storage unit 141, and transmits the meeting materials to the terminal device 200-1 whose terminal ID is “1” (Step S119). When either the conferring flag or the presence flag is not “1”, the access control unit 157 does not distribute the meeting materials.

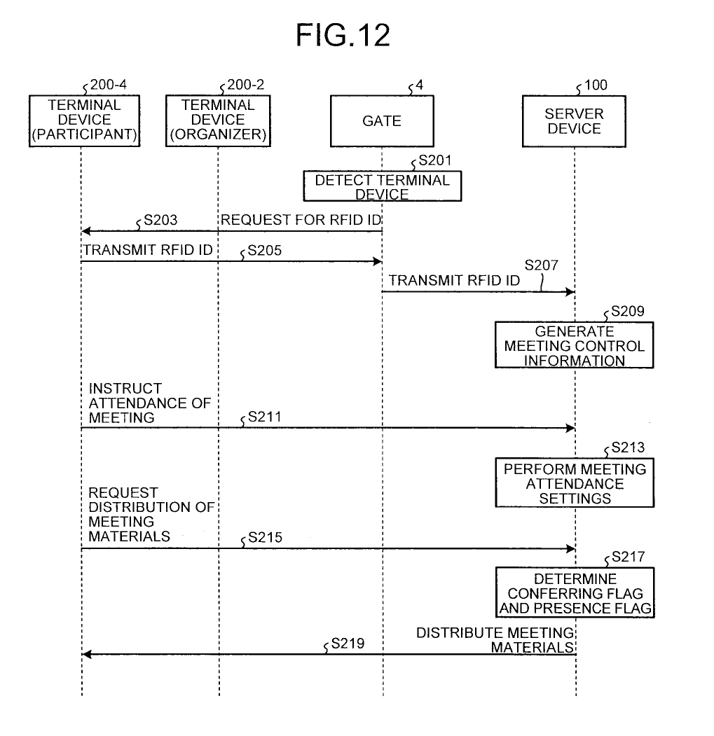

FIG. 12 shows an exemplary sequence of meeting attendance processing performed in the meeting system 1 according to the embodiment of the present invention. FIG. 12 illustrates an example of the meeting attendance processing when “Yamada” whose user ID is “D” attends the meeting later. In this embodiment, the flow of the meeting attendance processing from the entry to the meeting room 1 to the attendance at the meeting of “Yamada” whose user ID is “D” is illustrated. In the example illustrated in FIG. 12, “Yamada” whose user ID is “D” uses the terminal device 200-4.

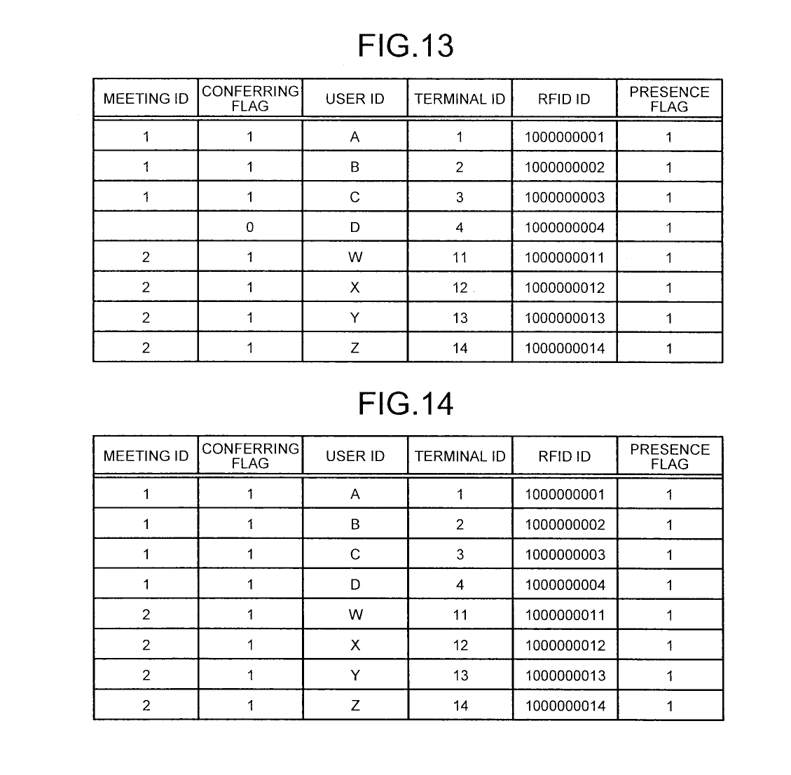

The processing from Steps S201 to S209 are the same as the processing from Steps S101 to S109 illustrated in FIG. 8, therefore the description thereof is omitted. FIG. 13 illustrated an example of the meeting control information at the time when “Yamada” whose user ID is “D” enters the meeting room 1 being stored in the meeting control information storage unit 149.

When “Yamada” whose user ID is “D” enters the meeting room 1, the meeting has already been started, thus “Yamada” performs the meeting attendance input through the operating and display unit 220 of the terminal device 200-4, and the instructing unit 241 of the terminal device 200-4 performs the meeting attendance input to instruct the attendance at the development review to the server device (Step S211). The meeting attendance input may include the meeting ID “1” of development review to be attended and the user ID “D” of the participant oneself.

Once the meeting attendance input is performed, the server device 100 (i.e., the management unit 151 and the conferring flag updating unit 155) confirms that there are no problems with the meeting ID and the user IDs included in the meeting attendance input, with reference to the meeting information illustrated in FIG. 3. The server device 100 (i.e., the management unit 151 and the conferring flag updating unit 155) then performs meeting attendance settings on the meeting control information (Step S213). Specifically, the conferring flag updating unit 155 sets the meeting ID of the meeting control information to “1” and updates the conferring flag of the meeting control information whose user ID is “D” to “1”. Once “Yamada” whose user ID is “D” attends the development review, the meeting control information being stored in the meeting control information storage unit 149 represents the meeting control information as illustrated in FIG. 14.

The processing from Steps S215 to S219 are the same as the processing from Steps S115 to S119 illustrated in FIG. 8, therefore, the description thereof is omitted.

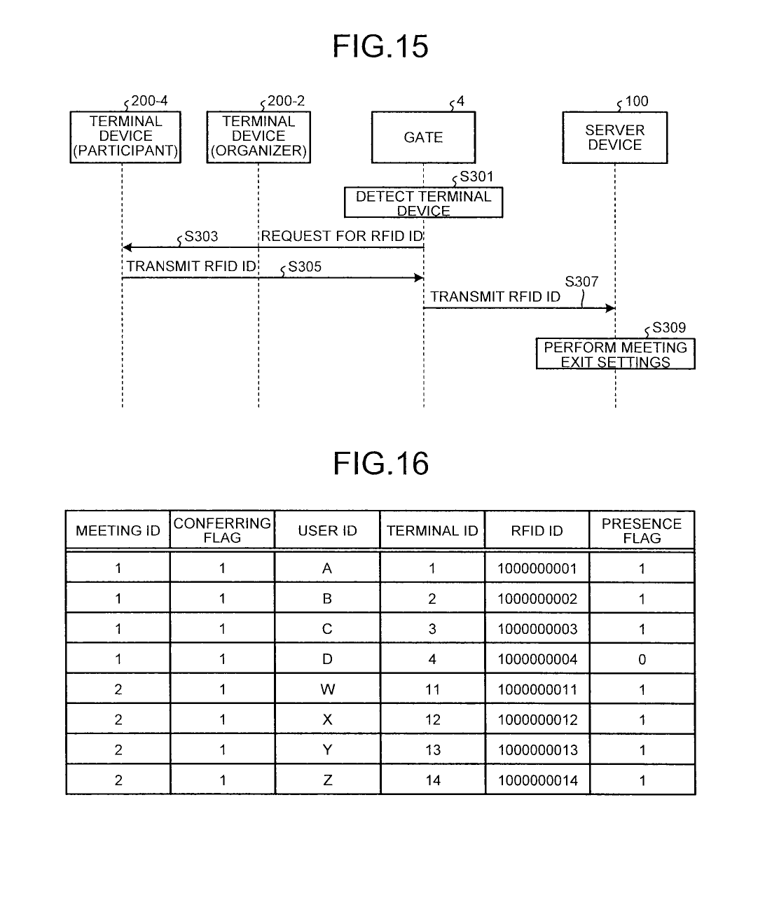

FIG. 15 shows an exemplary sequence of meeting exit processing performed in the meeting system 1 according to the embodiment of the present invention. FIG. 15 illustrates an example of the meeting exit processing when “Yamada” whose user ID is “D” leaves the development review during the meeting.

First, when “Yamada” whose user ID is “D” leaves the meeting room 1 carrying the terminal device 200-4, the gate 4 detects the RFID tag 201-4 attached to the terminal device 200-4 (Step S301).

The processing from Steps S303 to S307 are the same as the processing from Steps S103 to S107 illustrated in FIG. 8 therefore the description thereof is omitted.

Once the RFID ID “1000000004” of the RFID tag 201-4 is received from the gate 4, the server device 100 (i.e., the presence flag updating unit 153) performs meeting exit settings on the meeting control information whose RFID ID is “1000000004” (Step S309). Specifically, the presence flag updating unit 153 updates the presence flag of the meeting control information including the RFID ID “1000000004”, “1” to “0”. Once “Yamada” whose user ID is “D” leaves the meeting room 1 during the meeting, the meeting control information being stored in the meeting control information storage unit 149 represents the meeting control information as illustrated in FIG. 16.

If “Yamada” whose user ID is “D” returns to the development review, the same processing is performed as in the flowchart illustrated in FIG. 12 except for the following. The meeting control information of “Yamada” whose user ID is “D” is generated at Step S209, so the meeting control information is not generated here. The presence flag updating unit 153 updates the presence flag of the meeting control information whose RFID ID is “1000000004”, to “1”. “Yamada” whose user ID is “D” has already attended the development review, so the processing at Steps S211 and S213 are not performed.

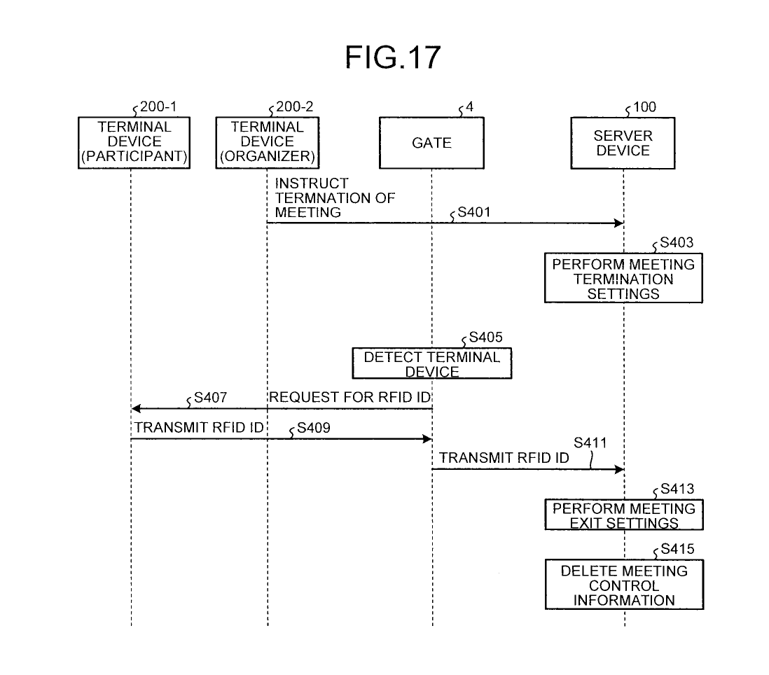

FIG. 17 shows an exemplary sequence of meeting termination processing performed in the meeting system 1 according to the embodiment of the present invention. FIG. 17 illustrates an example of the meeting termination processing of development review whose meeting ID is “1” and the flow of processing from the end of the meeting to the exit from the meeting room 1 by “Satoh” whose user ID is “A”.

Once the development review terminates, “Suzuki” who is the organizer of the meeting, whose user ID is “B”, performs a meeting termination input through the operating and display unit 220 of the terminal device 200-2. The instructing unit 241 of the terminal device 200-2 performs a meeting termination input to instruct the end of the development review to the server device 100 (Step S401). The meeting termination input includes the meeting ID “1” of the development review and the user IDs “A”, “B”, “C”, and “D” of the members who have attended the development review.

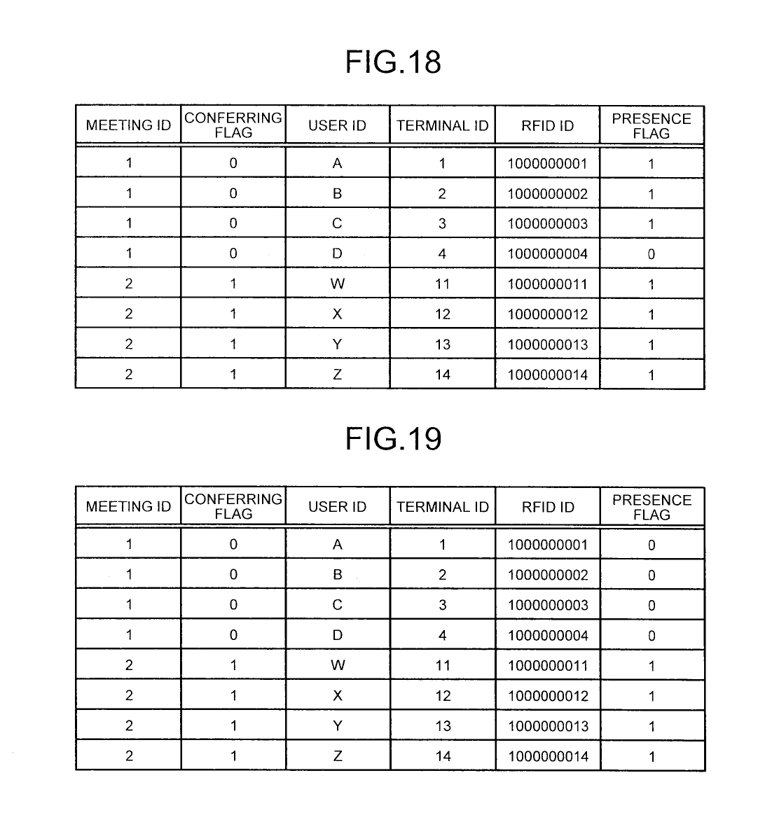

Once the meeting termination input is performed for the development review, the server device 100 (i.e., the conferring flag updating unit 155) performs meeting termination settings on the meeting control information (Step S403). Specifically, the conferring flag updating unit 155 updates the conferring flag of the meeting control information whose user IDs are “A”, “B”, and “C”, to “0”. The conferring flag updating unit 155 does not update the conferring flag of the meeting control information whose user ID is “D” because it is already “0”. Once the development review terminates, control information stored in the meeting control information storage unit 149 represents the meeting control information as illustrated in FIG. 18.

After that, “Suzuki” whose user ID is “B” and “Tanaka” whose user ID is “C” leave the meeting room 1 before “Satoh” whose user ID is “A” leaves the meeting room 1.

The processing from Steps S405 to S413 are the same as the processing from Steps S301 to S309 illustrated in FIG. 15, therefore the description thereof is omitted. Once “Satoh” whose user ID is “A” leaves the meeting room 1 during the meeting, the meeting control information stored in the meeting control information storage unit 149 represents the meeting control information as illustrated in FIG. 19.

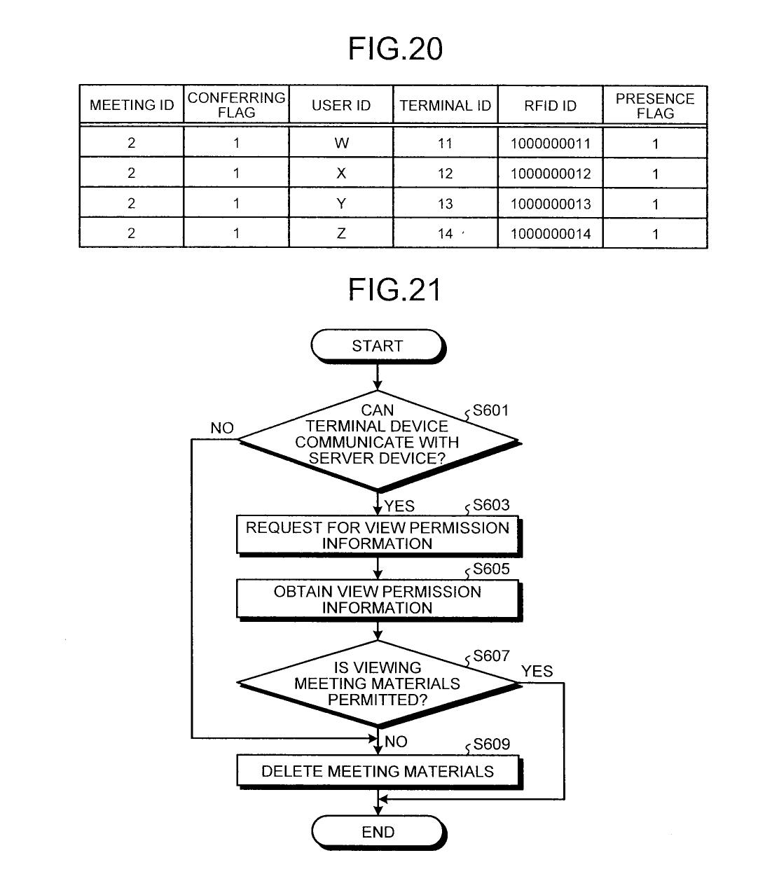

If the server device 100 (the management unit 151) confirms that the conferring flag and the presence flag are all “0” in the meeting control information whose terminal ID is “1”, the server device 100 (the management unit 151) deletes the meeting control information of the development review whose meeting ID is “1” from the meeting control information storage unit 149 (Step S415). Once all participants of the meeting leave the meeting room 1, the meeting control information stored in the meeting control information storage unit 149 represents the meeting control information as illustrated in FIG. 20.

FIG. 21 shows an exemplary meeting materials view determination processing performed in the terminal device 200 according to the embodiment of the present invention.

First, the terminal device 200 determines whether it can communicate with the server device 100 or not (Step S601).

If the terminal device 200 can communicate with the server device 100 (Yes at Step S601), the requesting unit 243 transmits the terminal ID to the server device 100, so that view permission information is requested (Step S603).

The requesting unit 243 obtains the view permission information of the terminal device represented by the transmitted terminal ID from the server device 100 (Step S605).

When the view permission information represents that viewing the meeting materials is permitted (Yes at Step S607), the display and control unit 245 continues displaying the meeting materials distributed from the server device 100 on the operating and display unit 220, and the processing terminates.

If the terminal device 200 cannot communicate with the server device 100 (No at Step S601), or when the view permission information represents that viewing the meeting materials is not permitted (No at Step S607), the display and control unit 245 discontinues displaying the meeting materials distributed from the server device 100 on the operating and display unit 220, and the deleting unit 247 deletes the meeting materials (Step S609).

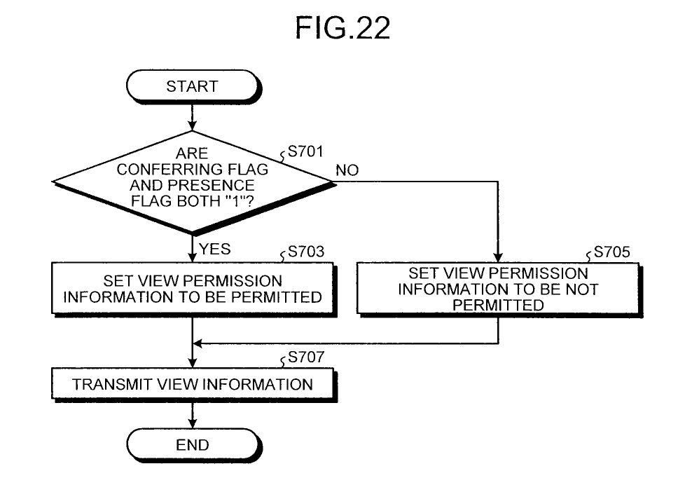

FIG. 22 shows an exemplary meeting materials view determination processing performed in the server device 100 according to the embodiment of the present invention.

When the terminal device 200 requests view permission information, the access control unit 157 determines whether both the conferring flag and the presence flag of the meeting control information whose terminal ID transmitted from the terminal device 200 are “1” or not (Step S701).

If both the conferring flag and the presence flag are “1” (Yes at Step S701), the access control unit 157 sets the view permission information so that viewing the meeting materials is permitted (Step S703) and transmits the view permission information to the terminal device 200 (Step S707).

If the conferring flag indicates “0” or the presence flag indicates “0” (No at Step S701), the access control unit 157 sets the view permission information so that viewing the meeting materials is not permitted (Step S705), and transmits the view permission information to the terminal device 200 (Step S707).

### MODIFICATIONS

The present invention is not limited to the above-described embodiment and there may be various alternatives and modifications of the embodiment as described below.

### Modification Example 1

The server device 100 determines view permission of the meeting materials in the embodiment described above, however, the terminal device 200 may alternatively determine view permission of the meeting materials. In the description below, differences from the embodiment will be mainly explained. The components similar to the embodiment are designated by reference numerals similar to those of the components in the embodiment, and overlapped explanation thereof will be omitted.

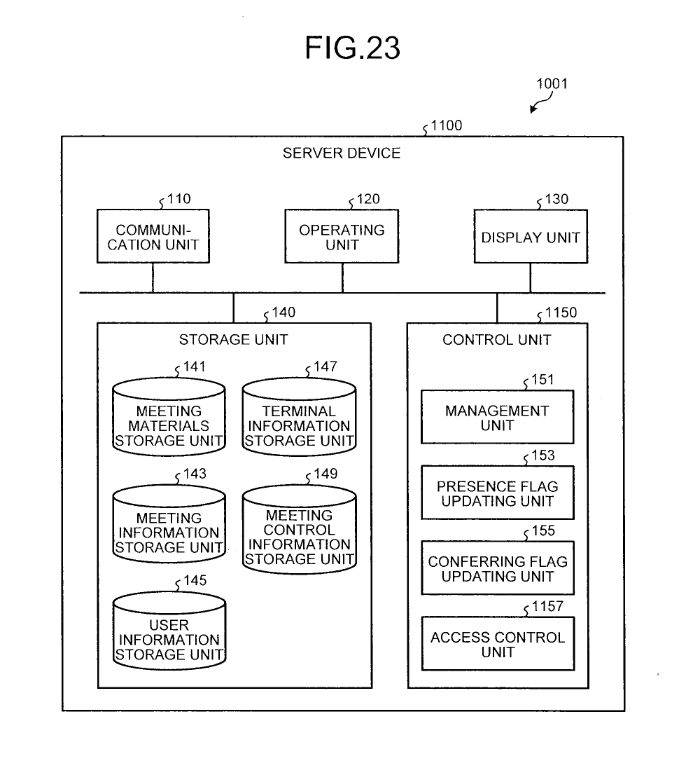

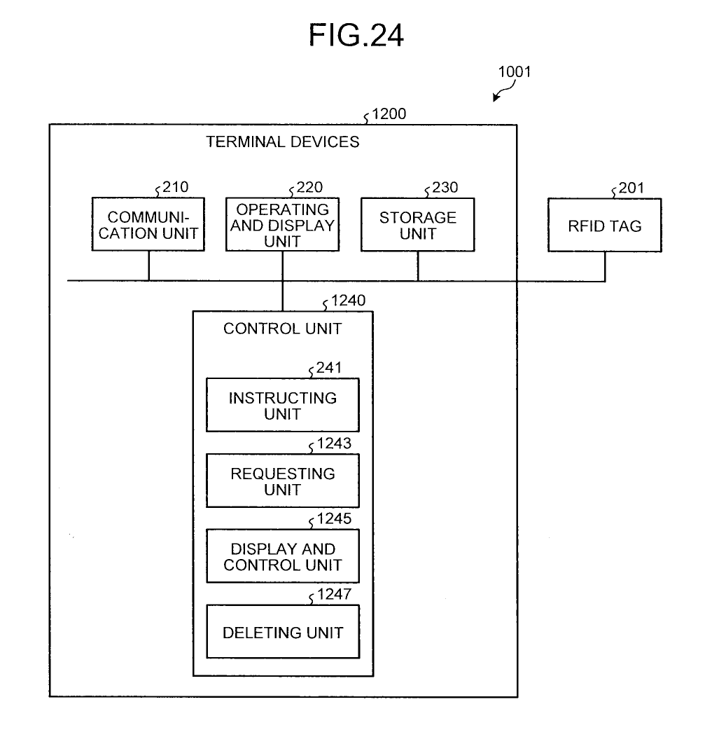

FIG. 23 shows an exemplary of the structure of a server device 1100 of a meeting system 1001 according to modification example 1. FIG. 24 shows an exemplary of the structure of a terminal device 1200 of the meeting system 1001 according to modification example 1. Specifically, the server device 1100 according to modification example 1 is different from the embodiment of the present invention in respect of an access control unit 1157 of a control unit 1150. The terminal device 1200 according to modification example 1 is different from the embodiment of the present invention in respect of a requesting unit 1243, a display and control unit 1245, and a deleting unit 1247 of a control unit 1240.

When the terminal device 1200 requests the presence flag and the conferring flag, the access control unit 1157 transmits the presence flag and the conferring flag to the terminal device 1200.

The requesting unit 1243 requests the presence flag and the conferring flag from the server device 1100 and receives them.

If both the presence flag and the conferring flag received from the requesting unit 1243 indicate “1”, the display and control unit 1245 continues displaying the meeting materials on the operating and display unit 220. If either the presence flag or the conferring flag indicates “0”, the display and control unit 1245 discontinues displaying the meeting materials on the operating and display unit 220.

When the presence flag received from the requesting unit 1243 indicates “0” or the conferring flag received from the requesting unit 1243 indicates “0”, the deleting unit 1247 deletes the meeting materials that have been received from the requesting unit 1243 and the meeting materials that have been distributed from the server device 1100.

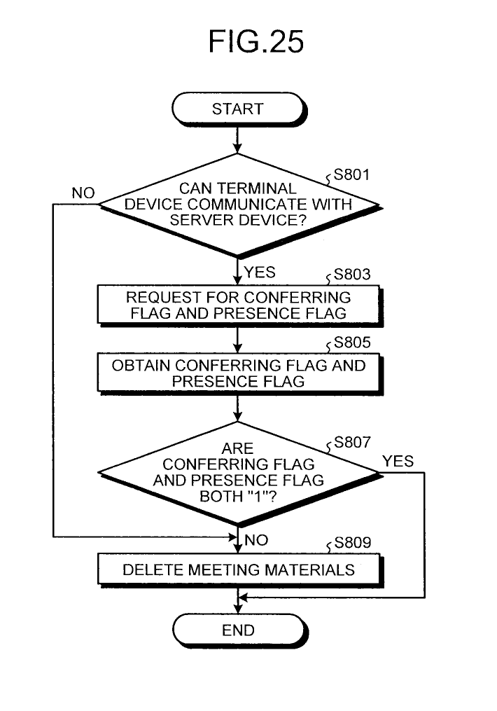

FIG. 25 shows an exemplary meeting materials view determination processing performed in the terminal device 1200 according to modification example 1.

First, the terminal device 1200 determines whether it can communicate with the server device 1100 (Step S801).

If the terminal device 1200 can communicate with the server device 1100 (Yes at Step S801), the requesting unit 1243 transmits the terminal ID to the server device 1100, so that the conferring flag and the presence flag are requested (Step S803).

The requesting unit 1243 obtains the conferring flag and the presence flag of the terminal device represented by the transmitted terminal ID from the server device 1100 (Step S805).

If both the conferring flag and the presence flag indicate “1” (Yes at Step S807), the display and control unit 1245 continues displaying the meeting materials distributed from the server device 1100 on the operating and display unit 220, and thereafter the processing terminates.

If the terminal device 1200 cannot communicate with the server device 1100 (No at Step S801) and when either the conferring flag or the presence flag indicates “0” (No at Step S807), the display and control unit 1245 discontinues displaying the meeting materials distributed from the server device 1100 on the operating and display unit 220, and the deleting unit 1247 deletes the meeting materials (Step S809).

### Modification Example 2

The embodiment has been described in which the RFID tag 201 is attached to the terminal device 200 as an object to be detected and the gate 4 that serves as a detection unit detects the RFID 201. The object to be detected and the detection unit in the present embodiment, however, are not limited thereto. Any detection unit and any object to be detected may be used as long as the detection unit can detect the object to be detected.

### Modification Example 3

In the above mentioned embodiment and modification example 1, the meeting system that holds the meeting mainly using the server device and the terminal devices has been described. Additionally, a projector, an electronic whiteboard, and a network conference device may be used in the meeting system.

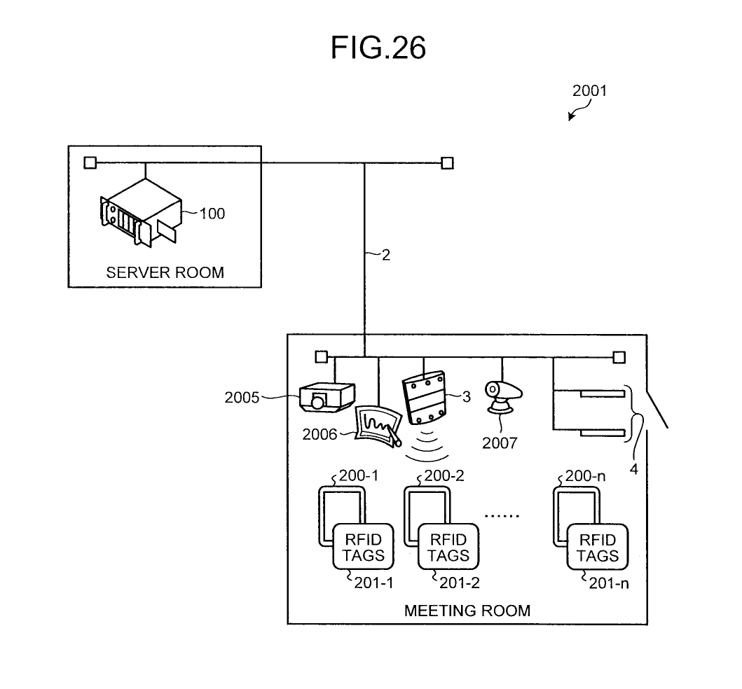

FIG. 26 shows an exemplary meeting system 2001 according to modification example 3 of the present invention. As illustrated in FIG. 26, a meeting system 1 further includes a projector 2005, an electronic whiteboard 2006, and a network meeting device 2007. Examples of the network conference device 2007 are a teleconference device, a video-conference device, and a Web conference device. With the meeting system 2001 according to the modification example 3, the meeting materials being accessed by the terminal device, that is, the meeting materials shared with the server device and the terminal device can be output to the projector 2005, the electronic whiteboard 2006, and the network meeting device 2007. The server device and/or the terminal device may perform meeting materials output processing to the projector 2005, the electronic whiteboard 2006, and the network meeting device 2007.

### Modification Example 4

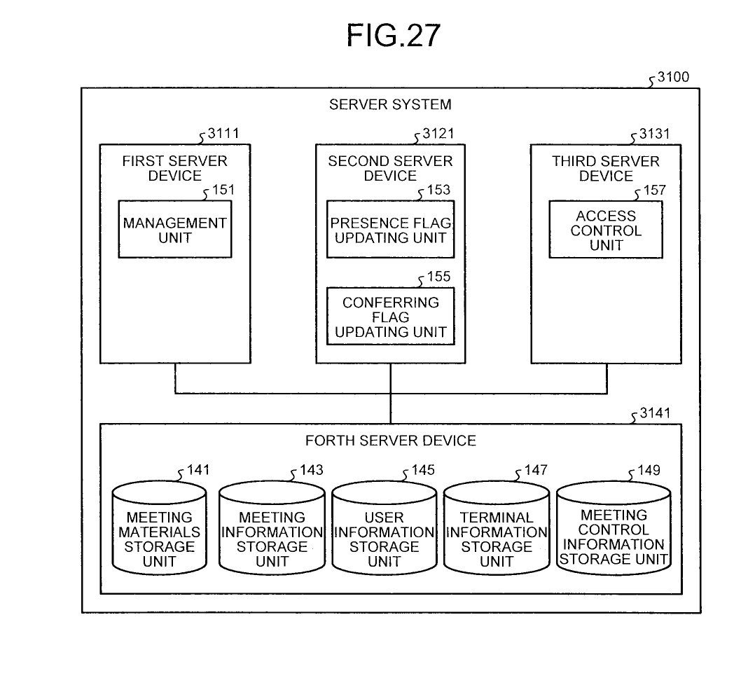

In the above-mentioned embodiment and modification examples, a single server device has been described. However, the present invention is not limited thereto. For example, the server device may be constituted with a plurality of devices. For example, as illustrated in FIG. 27, server device may be realized by a server system 3100 composed of a first server device 3111, a second server device 3121, a third server device 3131, and a forth server device 3141. In this modification example 4, the first server device 3111 includes a management unit 151, the second server device 3121 includes a presence flag updating unit 153 and a conferring flag updating unit 155, the third server device 3131 includes an access control unit 157, the fourth server device 3141 includes a meeting materials storage unit 141, a meeting information storage unit 143, a user information storage unit 145, a terminal information storage unit 147, and a meeting control information storage unit 149. In this modification example 4, each of the first server device 3111, the second server device 3121, and the third server device 3131 may communicate with the forth server device 3141.

### Modification Example 5

Alternatively, each part of server device of the above mentioned embodiment and modification examples may be replaced with each part of terminal device of the above mentioned embodiment and modification examples, respectively.

### Modification Example 6

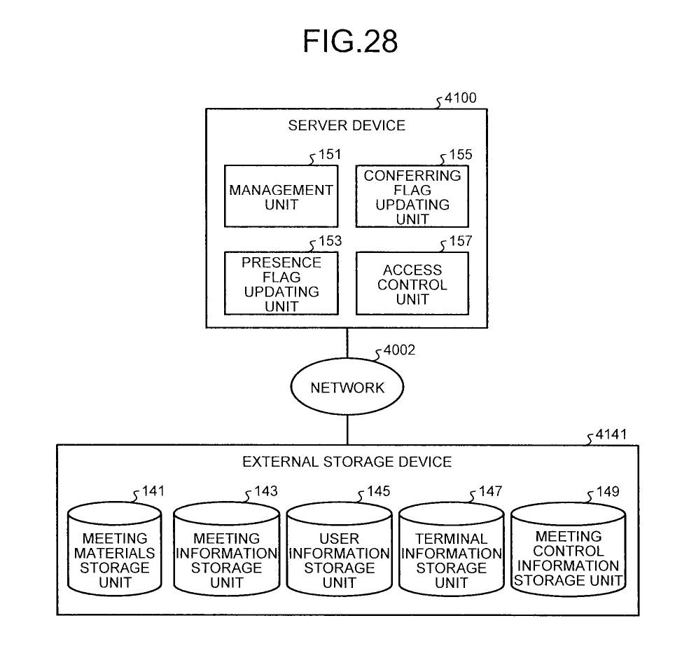

At least one piece of information to be used by the server device of the above mentioned embodiment and modification examples may be stored in a storage outside the meeting system, for example a cloud. For example, as illustrated in FIG. 28, an external storage device 4141 that stores the meeting materials storage unit 141, the meeting information storage unit 143, the user information storage unit 145, the terminal information storage unit 147, and the meeting control information storage unit 149 may be provided outside the server device 4100. In the modification example 6, each of the management unit 151, the presence flag updating unit 153, the conferring flag updating unit 155, and the access control unit 157 of server device 4100 may communicate, via a network 4002, with each of the meeting materials storage unit 141, the meeting information storage unit 143, the user information storage unit 145, the terminal information storage unit 147, and the meeting control information storage unit 149 of external storage device 4141.

Hardware Structure

Described below are exemplary hardware structures of the server device and the terminal device according to the embodiment and the modifications. The server device and the terminal device according to the embodiment and the modifications include a control device such as a CPU, a storage device such as a ROM and a RAM, an external storage device such as an HDD, a display device such as a display, an input device such as a keyboard or a mouse, and a communication device such as a communication interface. Hardware structure of the server device and the terminal device may be realized by a general computer.

The computer program executed by the server device and the terminal device according to the embodiment and the modifications is provided in a manner recorded as an installable or executable file format on a computer-readable recording medium, such as a compact disk read-only memory (CD-ROM), a compact disk recordable (CD-R), a digital versatile disk (DVD), and a flexible disk (FD).

In addition, the computer program executed by the server device and the terminal device according to the embodiment and the modifications may also be provided in a manner stored in a computer connected to a network such as the Internet so as to be downloaded via the network. The computer program executed by the server device and the terminal device according to the embodiment and the modifications may also be provided or distributed via a network such as the Internet. Furthermore, the computer program executed by the server device and the terminal device according to the embodiment and the modifications may also be provided in a manner embedded in a ROM, for example.

The computer program executed by the server device and the terminal device according to the embodiment and the modifications have a module structure for realizing the above-described components on the computer. Generally, the CPU may read the programs from the HDD and execute the programs on the RAM. Once the programs are executed, the above-described components are realized on the computer.

As described above, according to the present embodiment, even if a terminal device used by a participant to a meeting is mobile and/or portable, it is possible to manage that whether the terminal device of the participant exists in the meeting room or not. Above mentioned various embodiments of the present invention enable the terminal device of the participant of the meeting to provide a restriction of the place in which the meeting is being heled so that an access to the meeting materials is controlled. As a result, security against information leakage can be significantly increased.

Additionally, according to the present embodiment, access to the meeting materials is prohibited from outside of the meeting room even during the meeting, which can prevent people who are not involved in the meeting from accessing the meeting materials. This can further increase security against information leakage.

In particular, according to the present embodiment, even if the terminal device is taken outside of the meeting room, not only the distribution of the meeting materials is prohibited, but also the already distributed meeting materials are deleted. Therefore, even if a participant of the meeting has malicious end, information leakage can be prevented, so that security against information leakage increases.

Although the invention has been described with respect to specific embodiments for a complete and clear disclosure, the appended claims are not to be thus limited but are to be constructed as embodying all modifications and alternative constructions that may occur to one skilled in the art that fairly fall within the basic teaching herein set forth.

What is claimed is:

1. An information processing apparatus communicating with a device associated with a participant of an event, comprising:
a unit configured to detect the device upon the participant entering the event;
a unit configured to update a presence information in response to the detection;
a unit configured to update a conferring information upon the event being held; and
a unit configured to control access to event materials from the device according to a value of the presence information and the conferring information.

2. The information processing apparatus set forth in claim 1, wherein one of upon the value of the presence information indicating that the device does not exist in the event place and the value of the conferring information indicating that the event is not being held, the unit configured to control access prohibits the device from accessing the event materials.

3. The information processing apparatus set forth in claim 2, wherein one of upon the value of the presence information indicating that the device does not exist in the event place and the value of the conferring information indicating that the event is not being held, the unit configured to control access does not distribute the event materials to the device upon the device requesting distribution of the event materials.

4. The information processing apparatus set forth in claim 1, wherein upon the value of the presence information indicating that the device exists in the event place and the value of the conferring information indicating that the event is being held, the unit configured to control access allows the device to access the event materials.

5. The information processing apparatus set forth in claim 4, wherein upon the value of the presence information indicating that the device exists in the event place and the value of the conferring information indicating that the event is being held, the unit configured to control access distributes the event materials to the device upon the device requesting distribution of the event materials.

6. The information processing apparatus set forth in claim 2, wherein one of upon the value of the value of the presence information indicating that the device does not exist in the event place and the value of the conferring information indicating that the event is not being held, the unit configured to control access transmits view permission information representing that viewing event materials is not permitted to the device upon the device requesting view permission determination about the event materials.

7. The information processing apparatus set forth in claim 4, wherein one of upon the value of the presence information indicating that the device exists in the event place and the value of the conferring information indicating that the event is being held, the unit configured to control access transmits view permission information representing that viewing event materials is permitted to the device.

8. The information processing apparatus set forth in claim 1, wherein upon the device requesting the presence information and the conferring information, the unit configured to control access transmits the presence information and the conferring information to the device.

9. The information processing apparatus set forth in claim 1, wherein
upon the value of the presence information indicating that the device does not exist in the event place, the unit configured to update a presence information updates the value of the presence information so as to indicate that the device exists in the event place, in response to the detection, and
upon the value of the presence information indicating that the device exists in the event place, the unit configured to update a presence information updates the value of the presence information so as to indicate that the device does not exist in the event place, in response to the detection.

10. The information processing apparatus set forth in claim 1, wherein
the unit configured to update a conferring information updates the conferring information so as to indicate that the event is being held according to a event start input by an organizer of the event or a event attendance input by the participant, and
the unit configured to update a conferring information updates the conferring information so as to indicate that the event is not being held according to a event termination input by the organizer of the event.

11. The information processing apparatus set forth in claim 1, wherein
the unit configured to detect the device detests a radio frequency identification (RFID) tag associated with the device, and
the unit configured to detect the device is provided at an entrance of the event place and detects the RFID tag.

12. A event system comprising:
the information processing apparatus set forth in claim 1;
a device associated with a participant, the device including a unit configured to request access to event materials from the information processing apparatus.

13. The event system set forth in claim 12, wherein upon one of the value of the presence information indicating that the device does not exist in the event place and the value of the conferring information indicating that the event is not being held, the unit configured to control access prohibits the device from accessing the event materials.

14. The event system set forth in claim 13, wherein
the unit configured to request access requests, from the information processing apparatus, view permission determination regarding the event materials,
one of upon the value of the presence information indicating that the device does not exist in the event place and the value of the conferring information indicating that the event is not being held, the unit configured to control access transmits view permission information representing that viewing event materials is not permitted to the device upon the device requesting view permission determination regarding the event materials, and
the device further includes a unit configured to delete the event materials that have been already distributed from the information processing apparatus upon the view permission information transmitted from the information processing apparatus representing that viewing event materials is not permitted.

15. The event system set forth in claim 12, wherein
the unit configured to request access requests, from the information processing apparatus, the presence information and the conferring information,
upon the device requesting the presence information and the conferring information, the unit configured to control access transmits the presence information and the conferring information to the device, and
the device further includes a unit configured to delete the event materials that have been already distributed from the information processing apparatus, one of upon the value of the presence information transmitted from the information processing apparatus indicating that the device does not exist in the event place and the value of the conferring information transmitted from the information processing apparatus indicating that the event is not being held.

16. An event system comprising:
a device associated with a participant of an event;
a unit configured to detect the device upon the participant entering the event;
a unit configured to update a presence information in response to the detection;
a unit configured to update a conferring information upon the event being held; and
a unit configured to control access to event materials from the device according to a value of the presence information and the conferring information.

17. The event system set forth in claim 16, wherein one of upon the value of the presence information indicating that the device does not exist in the event place and the value of the conferring information indicating that the event is not being held, the unit configured to control access prohibits the device from accessing the event materials.

18. The event system set forth in claim 17, wherein
one of upon the value of the presence information indicating that the device does not exist in the event place and the value of the conferring information indicating that the event is not being held, the unit configured to control access sets view permission information representing view permission of the event materials to the device so that viewing event materials is not permitted, and
the event system further comprising
a unit configured to delete the event materials that have been already distributed to the device upon the view permission information representing that viewing event materials is not permitted.

19. The event system set forth in claim 16, further comprising a unit configured to delete the event materials that have been already distributed to the device one of upon the value of the presence information indicates that the device does not exist in the event place and the value of the conferring information indicating that the event is not being held.

20. A method of performing a processing of information communication to a device associated with a participant of an event, comprising:
detecting the device upon the participant entering the event;
updating a presence information in response to the detection;
updating a conferring information upon the event being held; and
controlling an access to event materials from the device according to a value of the presence information and the conferring information.
